(19) United States
(12) Patent Application Publication
(10) Pub. No.: US 2022/0206244 A1
(43) Pub. Date: Jun. 30, 2022

(54) LENS BARREL AND OPTICAL APPARATUS

(71) Applicant: CANON KABUSHIKI KAISHA, Tokyo (JP)

(72) Inventor: Yasuhiro Makita, Tokyo (JP)

(21) Appl. No.: 17/695,692

(22) Filed: Mar. 15, 2022

Related U.S. Application Data
(63) Continuation of application No. PCT/JP2020/046883, filed on Dec. 16, 2020.

(30) Foreign Application Priority Data
Dec. 26, 2019 (JP) 2019-236835

(51) Int. Cl. G02B 7/02; G02B 7/00

(52) U.S. Cl. CPC G02B 7/025; G02B 7/022; G02B 7/026; G02B 7/006

(57) ABSTRACT

A lens barrel includes an optical element with a peripheral portion having a side face and a planar bottom face. The lens barrel includes a first member configured to position the side face in a direction orthogonal to an optical axis, and a second member configured to position the bottom face in a direction of the optical axis. The first member and the second member are fixed in a state in which the first member and the second member are positioned relative to each other in the direction of the optical axis with an abutting face of the first member and an abutting face of the second member being abutted on each other.

### CROSS-REFERENCE TO RELATED APPLICATIONS

This application is a Continuation of International Patent Application No. PCT/JP2020/046883, filed Dec. 16, 2020, which claims the benefit of Japanese Patent Application No. 2019-236835, filed Dec. 26, 2019, both of which are hereby incorporated by reference herein in their entirety.

### TECHNICAL FIELD

The present invention relates to a lens barrel and an optical apparatus.

### BACKGROUND ART

There are known methods of, when a glass in the form of a flat plate (also referred to as a “flat glass”) is to be assembled into or held by a lens barrel, resiliently biasing the flat glass to a barrel abutting surface (also referred to as a barrel abutting face) of the lens barrel with a leaf spring, or by bonding the flat glass at its lateral surface, or by fixing the flat glass with thermal caulking. Japanese Patent Laid-Open No. 2018-54735 discloses a structure of fixing and holding the flat glass with thermal caulking. Japanese Patent Laid-Open No. 2009-3073 discloses a structure of bonding and holding the flat glass.

### CITATION LIST

### Patent Literature

PTL 1 Japanese Patent Laid-Open No. 2018-54735

PTL 2 Japanese Patent Laid-Open No. 2009-3073

In the holding structure disclosed in Japanese Patent Laid-Open No. 2018-54735, a relief shape to avoid interference is not formed in both of a ridge of the flat glass and a corner (angled edge portion) of the lens barrel into which the flat glass is inserted. Therefore, the ridge of the flat glass and the corner of the lens barrel may interfere with each other in some cases. If even a small R shape is formed at the corner, there is a possibility that, when the flat glass is pressed by the thermal caulking, the flat glass may break, or the flat glass may ride over an R-shaped portion at the corner of the lens barrel, whereby the flat glass may be inclined and fixed in an eccentric state. Here, the term “R shape” indicates roundness formed at a corner. In the holding structure disclosed in Japanese Patent Laid-Open No. 2009-3073, because a recess for the bonding is formed at the corner of the lens barrel into which the flat glass is inserted, the flat glass and the lens barrel are avoided from interfering with each other. With the recess formed in the lens barrel, the holding structure disclosed in Japanese Patent Laid-Open No. 2009-3073 is advantageous in protection of the flat glass and positioning accuracy, but it is disadvantageous in terms of machining cost.

### SUMMARY OF INVENTION

An aspect of embodiments provides a lens barrel beneficial in holding an optical element with a peripheral portion having a side face and a planar bottom face. An aspect of embodiments provides a lens barrel including an optical element with a peripheral portion having a side face and a planar bottom face. The lens barrel includes a first member configured to position the side face in a direction orthogonal to an optical axis, and a second member configured to position the bottom face in a direction of the optical axis. The first member and the second member are fixed in a state in which the first member and the second member are positioned relative to each other in the direction of the optical axis with an abutting face of the first member and an abutting face of the second member being abutted on each other.

Further features of the present invention will become apparent from the following description of exemplary embodiments with reference to the attached drawings.

### BRIEF DESCRIPTION OF DRAWINGS

FIG. 1A illustrates an example of configuration of a lens barrel according to a first embodiment.

FIG. 1B illustrates the example of configuration of the lens barrel according to the first embodiment.

FIG. 2A illustrates an example of configuration of a lens barrel according to a second embodiment.

FIG. 2B illustrates the example of configuration of the lens barrel according to the second embodiment.

FIG. 3A illustrates an example of configuration of a lens barrel according to a first comparative example.

FIG. 3B illustrates the example of configuration of the lens barrel according to the first comparative example.

FIG. 4A illustrates an example of configuration of a lens barrel according to a second comparative example.

FIG. 4B illustrates the example of configuration of the lens barrel according to the second comparative example.

### DESCRIPTION OF EMBODIMENTS

Embodiments of the present invention will be described below with reference to the accompanying drawings. The same members and so on throughout all the drawings to be referred in the following description of the embodiments are denoted by the same signs in principle (unless otherwise specified), and repeated description of those members and so on is omitted.

### COMPARATIVE EXAMPLES

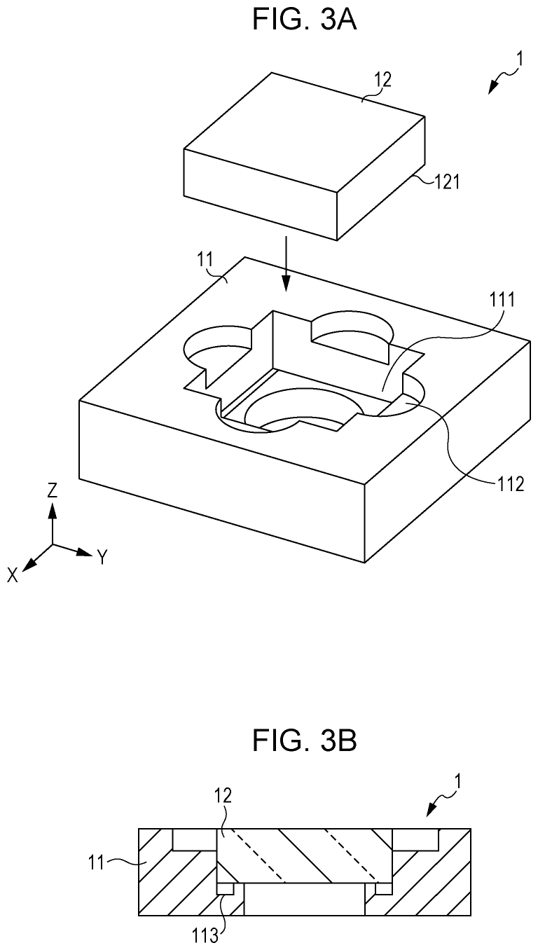

FIGS. 3A and 3B illustrate an example of configuration of a lens barrel 1 according to a first comparative example. FIG. 3A is an exploded perspective view of the lens barrel 1. The lens barrel 1 is constituted by inserting a flat glass 12 into a recess 111 that is formed in a lens barrel body 11. With the flat glass 12 placed in the recess 111, positioning of the flat glass 12 relative to the lens barrel body 11 is made in each of X-, Y-, and Z-axes. After the positioning of the flat glass 12 relative to the lens barrel body 11, the flat glass 12 is fixed to the lens barrel body 11 by pouring an adhesive into an adhesive groove 112. Although the flat glass 12 is fixed here by using an adhesive, for example, the flat glass 12 may also be fixed by caulking, or by using a retainer ring (also referred to as a pressing ring) or vis screws (a vis screw is also referred to as a vis). FIG. 3B is a sectional view of the lens barrel 1. As illustrated in FIG. 3B, in order to make the positioning between the lens barrel body 11 and the flat glass 12 in the Z-axis, a relief groove 113 is formed at a corner in a bottom surface of the recess 111 in the lens barrel body 11. Because the recess 111 in the lens barrel body 11 is usually formed by cutting from above with a blade of a milling machine, an R-shaped portion attributable to an R shape of the blade is formed at the corner of the recess 111. If the flat glass is inserted into the lens barrel body with the corner including the above-mentioned R-shaped portion, a ridge 121 of the flat glass 12 and the corner of the lens barrel body may interfere with each other. As a result, the flat glass may break or crack, or the flat glass may be mounted to the lens barrel in an inclined state (or an eccentrically inclined state) relative to the lens barrel. It may hence happen in some cases that the flat glass is not positioned within an allowable range. To reduce such inclination and eccentricity, as illustrated in FIG. 3B, the lens barrel 1 includes the relief groove 113 formed at the corner of the recess 111 in the lens barrel body 11. With the formation of the relief groove 113, an inner wall of the lens barrel body 11 and a bottom surface of the flat glass 12 can be abutted on each other without causing interference therebetween with no need of chamfering the ridge 121 of the flat glass 12, and accurate positioning can be performed.

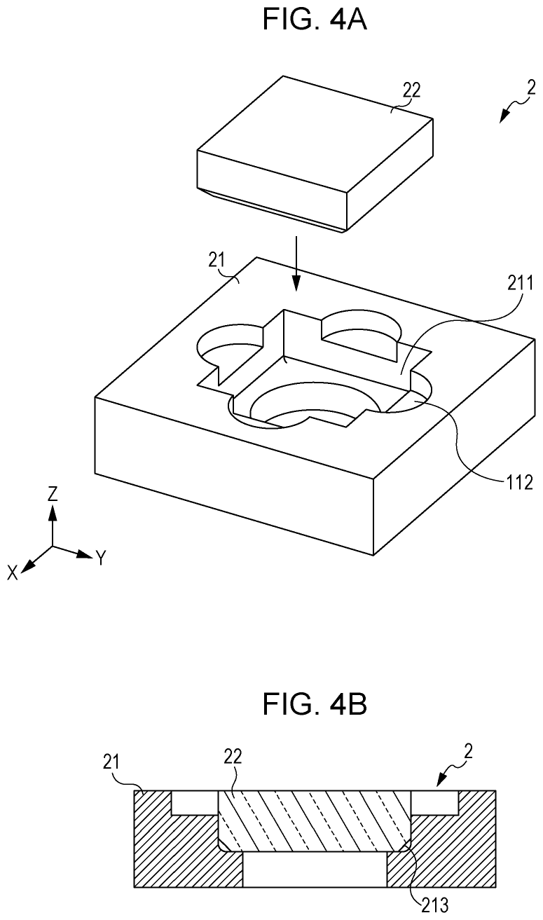

While FIGS. 3A and 3B illustrate the first comparative example in which the relief groove 113 is formed in the recess 111, FIGS. 4A and 4B illustrate a second comparative example. FIGS. 4A and 4B illustrate an example of configuration of a lens barrel 2 according to the second comparative example. In the lens barrel 2 illustrated in FIGS. 4A and 4B, a ridge of a flat glass 22 is chamfered as denoted by 213 instead of forming the relief groove 113 in the lens barrel 1 illustrated in FIG. 3. FIG. 4A is an exploded perspective view of the lens barrel 2. The lens barrel 2 is constituted by inserting the flat glass 22 into a recess 211 that is formed in a lens barrel body 21. FIG. 4B is a sectional view of the lens barrel 2. As illustrated in FIG. 4B, in order to make positioning between the lens barrel body 21 and the flat glass 22 in the Z-axis, the ridge of the flat glass 22 is chamfered as denoted by 213. Accordingly, even when the corner of the recess 211 in the lens barrel body 21 has an R shape attributable to machining to form the recess 211, an inner wall of the lens barrel body 21 and a bottom surface of the flat glass 22 can be abutted on each other without causing interference therebetween, and accurate positioning can be performed.

With each of the two holding structures described above, the interference between the corner of the recess in the lens barrel body and the ridge of the flat glass can be reduced, but an additional cost is required for machining to form the relief groove 113 or the chamfering 213 and for dimensional inspection. Furthermore, when the relief groove 113 is to be formed, the size of the flat glass 12 needs to be increased additionally corresponding to a width of the relief groove 113, whereby the sizes of the lens barrel and a lens held by the lens barrel may be increased. Also, when the ridge of the flat glass is chamfered, the size of the flat glass 22 needs to be increased additionally corresponding to a width of the chamfering. Thus, the two holding structures described above are disadvantageous in terms of cost and size.

### First Embodiment

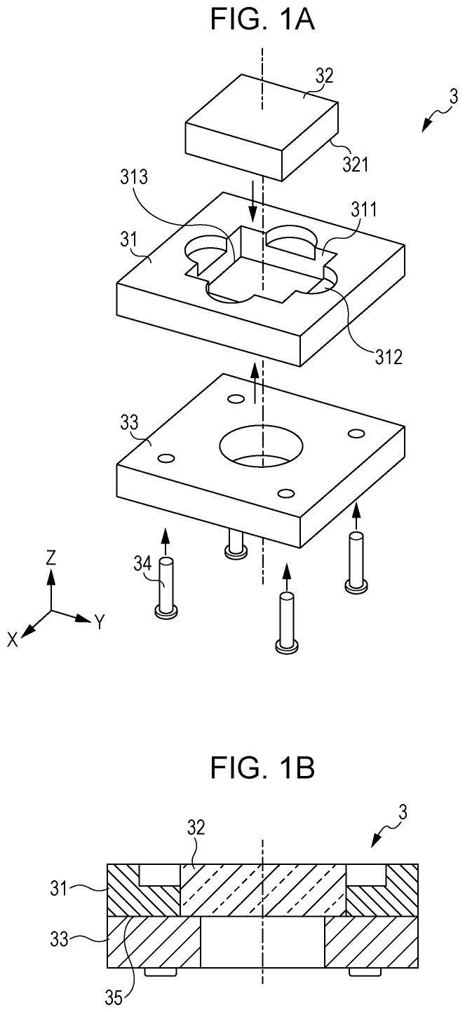

FIGS. 1A and 1B illustrate an example of configuration of a lens barrel 3 according to a first embodiment. The lens barrel 3 constitutes an optical apparatus in cooperation with other components (for example, a light source, an optical element, a detection element, an image pickup element, and a processing unit). FIG. 1A is an exploded perspective view of the lens barrel 3. In FIG. 1A, the lens barrel 3 is constituted by fixing a holder 33 to a lens barrel body 31 from below, and by inserting a flat glass 32 (or an optical filer) into the lens barrel body 31 from above. The flat glass 32 does not always needs to be flat in its entirely and just needs to be an optical element with at least a peripheral portion being flat. The peripheral portion has a lateral surface (also referred to as a side face) and a flat bottom surface (also referred to as a planar bottom face). A surface of the flat glass 32 on an opposite side to the bottom surface may not need to be flat. Assembly procedures are as follows. First, the holder 33 is engaged with the lens barrel body 31 and is fixed (fastened) thereto by using vis screws 34. The lens barrel body 31 and the holder 33 have abutting surfaces 35 (also referred to as abutting faces) that are to be abutted on each other in a direction of an optical axis (Z-axis). Positioning of the holder 33 relative to the lens barrel body 31 is made in the direction of the optical axis by fixing those members in a mutually abutted state. The optical axis may be set to a specific axis that extends along a direction perpendicular to the bottom surface of the flat glass 32 (namely, a thickness direction of the flat glass). Then, the flat glass 32 is inserted into a through-hole 311 of the lens barrel body 31 fixed to the holder 33, whereby positioning of the flat glass 32 relative to the lens barrel body 31 is made in each of the X-, Y-, and Z-axes. Here, the positioning by the lens barrel body 31 (first member) is made in such a manner that lateral surfaces of peripheral portions of the flat glass 32 are positioned in the directions of the X- and Y-axes by a surface defining the through-hole 311 formed in the lens barrel body 31. Moreover, the positioning by the holder 33 (second member) is made in such a manner that bottom surfaces of the peripheral portions of the flat glass 32 are positioned in the Z-axis direction by a surface located around a through-hole formed in the holder 33 and extending along a direction perpendicular to the optical axis position. After the above-described positioning of the flat glass 32, the flat glass 32 is fixed to the lens barrel body 31 by pouring an adhesive into an adhesive groove 312. Although the flat glass 32 is fixed here by using an adhesive, for example, a fixing method is not limited to the above-mentioned example, and the flat glass 32 may also be fixed by caulking, or by using a retainer ring or vis screws. FIG. 1B is a sectional view of the lens barrel 3 after being assembled. Pay attention here to a ridge 321 of the flat glass 32 and a ridge 313 of the lens barrel body 31. In this embodiment, the flat glass 32 is positioned and held by using two components, namely the lens barrel body 31 and the holder 33. Therefore, this embodiment does not include the R-shaped corner that exists in the recess of the lens barrel body, and that causes the problems in the lens barrels 1 and 2 according to the comparative examples. Accordingly, there are no needs of forming the relief groove in the lens barrel body as in the first comparative example and chamfering the flat glass as in the second comparative example. As a result, this embodiment can provide the lens barrel that is advantageous in protection of the flat glass, positioning accuracy, and machining cost. This embodiment can hence provide the lens barrel that is advantageous in holding the flat glass.

### Second Embodiment

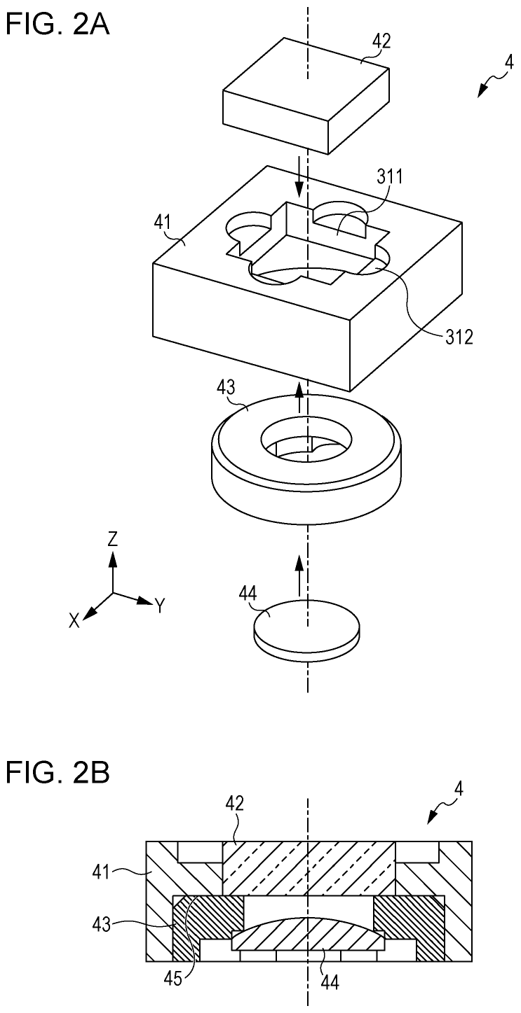

FIGS. 2A and 2B illustrate an example of configuration of a lens barrel 4 according to a second embodiment. FIG. 2A is an exploded perspective view of the lens barrel 4. In FIG. 2A, the lens barrel 4 is constituted by fixing a holder 43 to a lens barrel body 41 from below, and by inserting a flat glass 42 (or an optical filer) into the lens barrel body 41 from above. FIG. 2B is a sectional view of the lens barrel 4 after being assembled. The holder 43 includes an external screw (a male screw) formed in its outer peripheral portion and is screwed into the lens barrel body 41 including an internal screw (a female screw) that is formed in its inner peripheral portion and that can be meshed with the external screw. The holder 43 is fixed (fastened) by screwing it into the lens barrel body 41 until reaching an abutting surface 45 of the lens barrel body 41. An optical member 44 is fixed to the holder 43 by using an adhesive, for example. A method of fixing the holder 43 and the optical member 44 is not limited to the above-mentioned example, and the flat glass 42 may also be fixed by caulking, or by using a retainer ring or vis screws.

In the configuration according to this embodiment, since the lens barrel body 41 is configured to position the flat glass 42 in the directions of the X- and Y-axes, the lens barrel body 41 generally has a rectangular shape and is suitable for cutting with a milling machine. Furthermore, since the optical member 44 held by the holder 43 is a lens with refractive power (curvature in at least one of an incident side and an emergent side), the holder 43 generally has a cylindrical shape and is suitable for cutting with a lathe. Stated in another way, division of the lens barrel body into two parts is made in the structure of the first embodiment (FIGS. 1A and 1B) for the purpose of eliminating the need of forming the relief groove, while that division further serves to make the machining method different for the lens barrel body 41 and the holder 43 in the structure of the second embodiment (FIGS. 2A and 2B). As a result, this embodiment can not only provide similar advantageous effects to those in the first embodiment, but also can further reduce the machining cost.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A lens barrel including an optical element with a peripheral portion having a side face and a planar bottom face, the lens barrel comprising:
a first member configured to position the side face in a direction orthogonal to an optical axis; and
a second member configured to position the bottom face in a direction of the optical axis,
wherein the first member and the second member are fixed in a state in which the first member and the second member are positioned relative to each other in the direction of the optical axis with an abutting face of the first member and an abutting face of the second member being abutted on each other.

2. The lens barrel according to claim 1, wherein the first member and the second member are fastened with a screw.

3. The lens barrel according to claim 2, wherein a screw formed in the first member and a screw formed in the second member are screwed with each other.

4. The lens barrel according to claim 1, wherein the first member is configured to position the side face with a face of the first member defining a through-hole formed in the first member.

5. The lens barrel according to claim 1, wherein the second member is configured to position the bottom face with a face of the second member that is around a through-hole formed in the second member and that extends along the direction orthogonal to the optical axis.

6. The lens barrel according to claim 1, wherein the optical element includes an optical filter.

7. The lens barrel according to claim 1, wherein the lens barrel includes another optical element held by the second member.

8. The lens barrel according to claim 7, wherein the second member has a cylindrical shape and the another lens is held in the second member.

9. The lens barrel according to claim 1, wherein the first member and the side face are adhered to each other.

10. An optical apparatus comprising:
a lens barrel including an optical element with a peripheral portion having a side face and a planar bottom face,
the lens barrel comprising:
a first member configured to position the side face in a direction orthogonal to an optical axis; and
a second member configured to position the bottom face in a direction of the optical axis,
wherein the first member and the second member are fixed in a state in which the first member and the second member are positioned relative to each other in the direction of the optical axis with an abutting face of the first member and an abutting face of the second member being abutted on each other.
